(19) United States
(12) Patent Application Publication
(10) Pub. No.: US 2004/0017499 A1
(43) Pub. Date: Jan. 29, 2004

(54) Digital still camera

(76) Inventor: Yasuhito Ambiru, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/441,222

(22) Filed: May 20, 2003

(30) Foreign Application Priority Data
May 21, 2002 (JP) 2002-146353

(51) Int. Cl. H04N 5/222

(52) U.S. Cl. 348/333.12

(57) ABSTRACT

A digital still camera having a camera body, an LCD provided on the back of the camera body, and a touch panel covering the LCD. Icons are printed on the touch panel, at positions located on the left side of the LCD. The user may touch the icons to select any one of the functions of the digital still camera.

### CROSS-REFERENCE TO RELATED APPLICATIONS

This application is based upon and claims the benefit of priority from the prior Japanese Patent Application No. 2002-146353, filed May 21, 2002, the entire contents of which are incorporated herein by reference.

### BACKGROUND OF THE INVENTION

1. Field of the Invention

The present invention relates to a digital still camera that comprises a touch panel used as input means.

2. Description of the Related Art

Conventional digital still cameras have buttons on the top and back of the camera body. Users may push the buttons to set the stroboscopic unit, select zooming photography and to perform operations on reproduced images, such as image feeding, image magnifying and image reducing. It is demanded that digital still cameras should perform more functions and should yet be smaller. However, it is difficult to fulfill both demands at the same time. To impart more functions to the cameras, it is necessary to provide more buttons on the camera body or to deepen the operation-menu nest. To make the cameras smaller, it is necessary to provide less buttons, thereby to render the operation-menu nest even deeper.

If more buttons are arranged on the camera body, the camera can hardly become smaller. If the operation-menu nest is deepened, the camera operability will decrease. In view of this, digital cameras have been developed, which have a touch panel that is used as input means, making it unnecessary to use additional mechanical buttons. The touch panel covers the LDC screen provided on the back of the camera body. When touched with the user's finger, the touch panel determines the coordinates of the position at which the finger contacts the touch panel. On a digital still camera of this type, the user may operate a mechanical buttons or touch an icon displayed on the touch panel, thereby to display a menu consisting of various items on the LCD display screen. The user may then touch one of the menu items, selecting a function and causing the camera to perform the function thus selected.

With the conventional still camera, the user must carry out two or more operations to have any desired icon displayed on the LCD screen. To do so is cumbersome for the user. To free the user from the cumbersome task, a digital still camera that keeps displaying some ions, which may be frequently selected. When the user touches such an icon with the finger, however, his or her hand may very likely to cover the LCD screen. In this case, the hand conceals almost all image displayed on the LCD screen, which is either being photographed or has been reproduced. When the image being photographed is concealed, the user may lose release timing. Hence, the conventional digital still cameras are not so easy to operate as is desired.

### BRIEF SUMMARY OF THE INVENTION

An object of the present invention is to enhance the operability of digital still cameras.

To attain the object, a digital still camera according to this invention comprises a photographing unit which converts optical image into electric image signal; a recording unit which records the image signal generated by the photographing unit, on a data-recording medium; a display unit which has a display screen and which displays an image represented by one of the image signal generated by the photographing unit and the image signal recorded on the data-recording medium; a touch panel which has a greater area than the screen of the display unit, covers the display screen and is designed to input user instructions; and a shutter key to set photographing timing. The shutter key is provided on an upper side of the touch panel, and an operation region to be touched to select a function of the digital still camera is provided on the touch panel, outside the display screen, and on at least one of a left side, right side and lower side of the screen.

Icons that are frequently selected are provided in the form of printed patterns, on, for example, the left side of the display screen (e.g., LCD screen). When the user holds the camera and touches any one of the icons to take pictures, the image displayed on the display screen and being photographed is not concealed with the user's hands. Hence, the user would not lose release timing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the preferred embodiments given below, serve to explain the principles of the invention.

FIG. 1 is a block diagram of a digital still camera according to one embodiment of the present invention;

FIG. 2 is a back view of the digital still camera, showing the touch panel and the input keys provided on the body of the digital still camera;

FIG. 3A is a back view of the camera, depicting areas in the touch panel;

FIG. 3B is a back view of the camera, showing the arrangement of the touch panel, color LCD and silk-printed patterns;

FIG. 4 is a back view of a digital still camera according to a second embodiment of the invention;

FIG. 5 is a back view of a digital still camera according to a third embodiment of this invention;

FIG. 6 is a back view of a digital still camera according to a fourth embodiment of the invention;

FIG. 7 is a back view of a digital still camera according to a fifth embodiment of the present invention;

FIG. 8 is a back view of a digital still camera according to a sixth embodiment of the present invention;

FIG. 9 is a back view of a digital still camera according to a seventh embodiment of the invention; and

FIG. 10 is a back view of a digital still camera according to an eighth embodiment of the present invention.

### DETAILED DESCRIPTION OF THE INVENTION

Embodiments of the invention will be described in detail, with reference to the accompanying drawings.

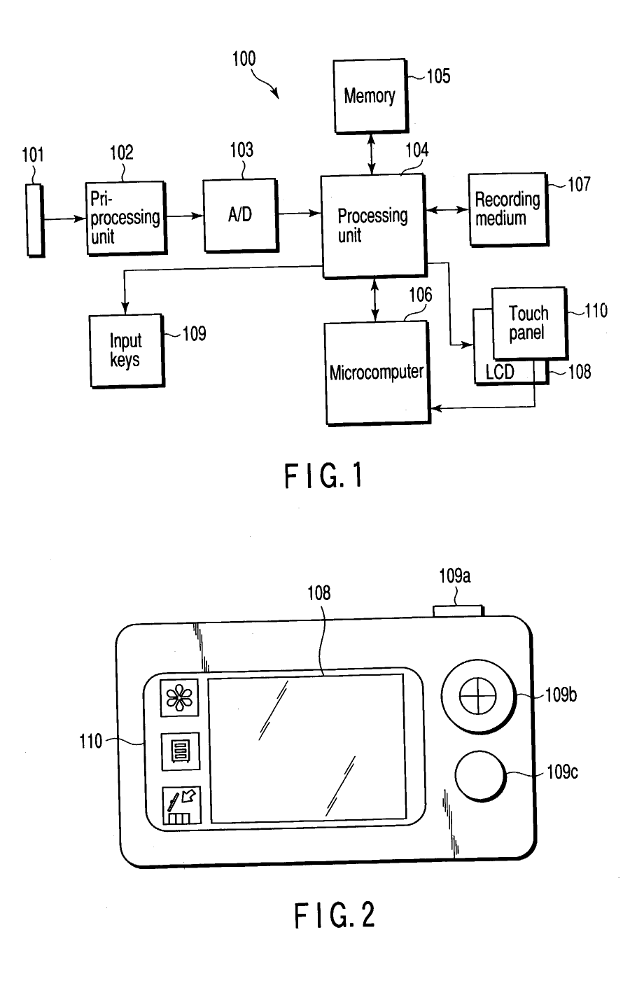

FIG. 1 is a block diagram of a digital still camera according to one embodiment of the present invention. The camera comprises a solid-state imaging element 101, a pre-processing unit 102, an A/D converter 103, a processing unit 104, a memory 105, a microcomputer 106, a LCD 108, input keys 109, and a touch panel 110. The solid-state imaging element 101 generates an image signal corresponding to light received. The pre-processing unit 102 amplifies and filters the image signal, which is input to the A/D converter 103. The A/D converter 103 converts the signal to digital signal. The digital signal is stored into the memory 105 as image data. The microcomputer 106 controls the digital still camera on the whole in accordance with the instructions supplied from the input keys 109 (including the shutter key and the cross key) or from the touch panel 110. The microcomputer 106 writes the image data stored in the memory 105, into a recording medium 107 such as a memory card. It also supplies the image data to the LCD 108, which displays the image represented by the image data.

FIG. 2 is a back view of the digital still camera, showing the touch panel 110 and the input keys 109. As FIG. 2 shows, the keys 109 include a shutter key 109a, a cross key 109b, and a mode-changing key 109c. When depressed, the shutter key 109a releases the shutter. When operated, the cross key 109b sets a direction and functions enter key. When pushed, the mode-changing key 109c changes the operating mode of the camera, from the photographing mode to image-reproducing mode or vice versa. As seen from FIG. 2, the touch panel 110 and the LCD 108 are provided on the back of the camera body. (The LCD 108 is, more precisely, a display screen of a color LCD.) The input keys 109 are input means, each having a movable mechanical member. The touch panel 110 is transparent and covers the LDC 108. When touched with the user's fingertip, the touch panel 110 determines the coordinates of the position at which the fingertip contacts it.

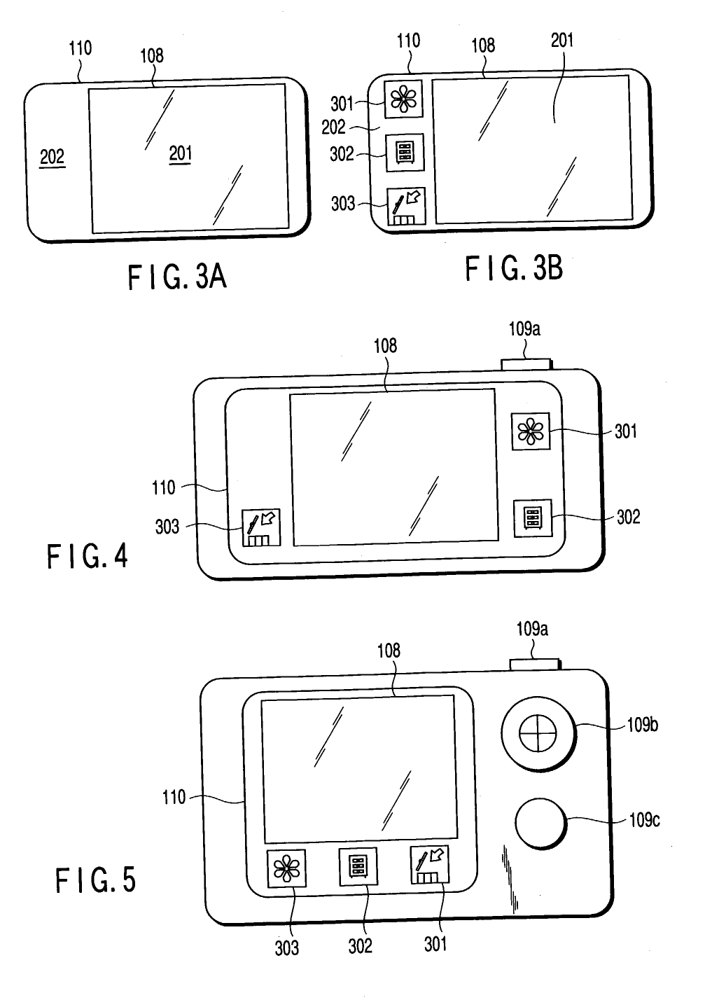

FIG. 3A is a back view of the camera, depicting the touch panel 110. As FIG. 3A shows, the touch panel 110 consists a touch part 201 and a silk-printed part 202. The touch part 201 covers the LCD 108. The user may touch the touch part 201 to select one of the icons (i.e., operation buttons) displayed beneath the touch part 201. The silk-printed part 202 has silk-printed characters and patterns that indicate the various functions that the digital still camera can perform.

FIG. 3B is a diagram showing the arrangement of the touch panel 110, color LCD 108, a display icon 301, a menu icon 302 and a trash icon 303. The icons 301, 302 and 303 are silk-printed on the inner surface of the silk-printed part 202 by an appropriate method. The user may touch the display icon 301 to cause the color LCD 108 to display non-image data (e.g., characters). He or she may touch the menu icon 302 to cause the color display 108 to display a menu. He or she may touch the trash icon 303 to cause the color LCD 108 to stop displaying the image being photographed.

The color LCD 108 may display icons that indicate other functions. To have these icons displayed, the user may first touch the menu icon 302, causing the color LCD 108 to display the menu, and then select one of the items of the menu thus displayed. These icons 301, 302 and 303 are frequently touched. Since they are provided on the silk-printed part 202 of the touch panel 110, the operability of the digital still camera is greatly enhanced.

As FIGS. 3A and 3B show, the silk-printed part 202 lies on the left-hand side of the color LCD 108. If the silk-printed part 202 lay on the upper side of the color LCD 108 and the user touched the part 202 with the thumb, the user's hand would conceal the screen of the color LCD 108. Since the silk-printed part 202 is located on the left of the LCD 108, the LCD 108 is not concealed at all, provided that the user touches the part 202 with the thumb or one of fingers of the left hand. The user can therefore operates the camera, while viewing the image which displayed on the LCD 108 and which is being photographed. The user may operate the camera, touching the silk-printed part 202 with the thumb of the left hand and manipulating the cross key 109b (FIG. 2) with the thumb of the right hand, without concealing the color LDC 108 with the hands. Further, having the structure described above, the camera of this invention needs to be operated with both hands. Hence, the user is not likely to drop the camera as in the case he or she holds the camera with the right hand only.

FIG. 4 is a back view of a digital still camera according to a second embodiment of the invention. As FIG. 4 depicts, the touch panel 110 of the camera has two silk-printed parts, as well as a color LCD 108. The silk-printed parts are provided on the left and right sides of the color LCD 108, respectively. The right silk-printed part has a display icon 301 and a menu icon 302, whereas the left silk-printed part has a trash icon 303. The user may hold and operate the camera with both hands, without concealing the color LCD 108 with the hands, if he or she pushes the trash icon 303 with the thumb of the left hand and the display icon 301 or menu icon 302 with the thumb of the right hand, for example. The digital still camera may have more or less icons than those shown in FIG. 4. Further, the silk-printed parts may be located at least one position; they may be provided on the left side of the LDC 108, on the right or lower side of the LCD 108.

FIG. 5 is a back view of a digital still camera according to a third embodiment of this invention. As seen from FIG. 5, the touch panel 110 of the camera one silk-printed part. The silk-printed part is provided on the lower side of the color LCD 108. It has a display icon 301, a menu icon 302 and a trash icon 303. Note that the shutter key 109a, display key 109b and mode-changing key 109c are located on the right side of the touch panel 110. The user can operate the camera without concealing the color LCD 108 with the hands, by touching the display icon 301, menu icon 302 or trash icon 303 with the thumb of the left hand and by pushing the cross key 109b or mode-changing key 109c with the thumb of the right hand, for example. The camera may have more or less keys and more or less icons, than those shown in FIG. 5. Moreover, the keys 109b and 109c may be located on the left or lower side of the touch panel 110, not on the right side of the panel 110 as shown in FIG. 5.

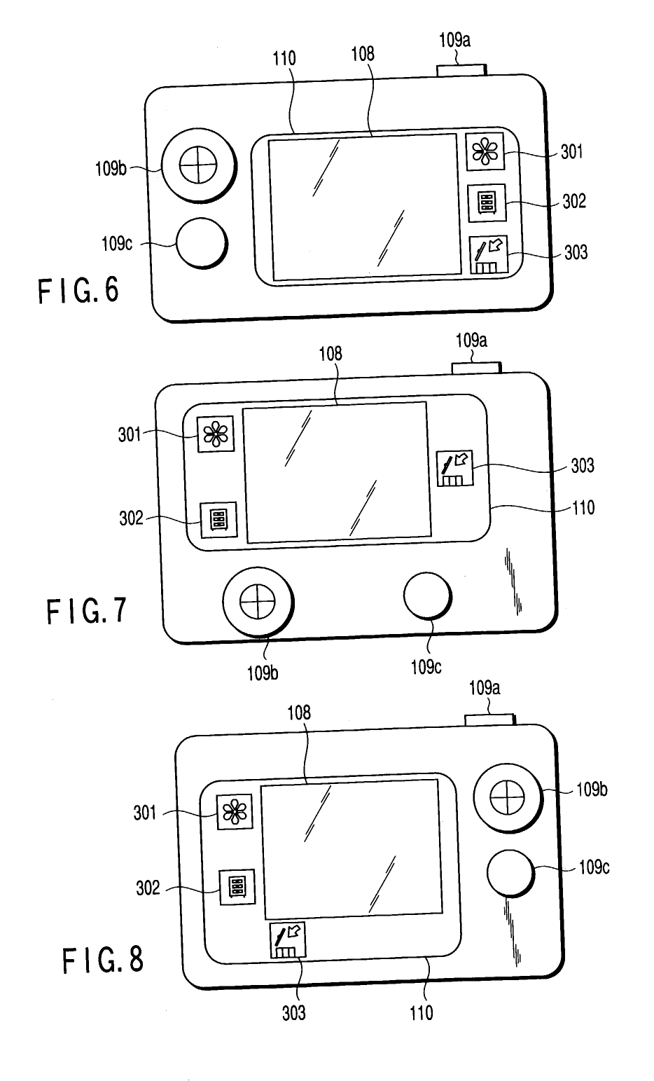

FIG. 6 is a back view of a digital still camera according to a fourth embodiment of the invention. As FIG. 6 depicts, the panel 110 of this camera has one silk-printed part. The silk-printed part lies on the right side of the color LCD 108. It has a display icon 301, a menu icon 302 and a trash icon 303. Note that the keys 109a, 109b and 109c are located on the left side of the touch panel 110. The user can operate the camera without concealing the color LCD 108 with the hands, by touching the display icon 301, menu icon 302 or trash icon 303 with the thumb of the right hand and by pushing the cross key 109b or mode-changing key 109c with the thumb of the left hand, for example. The camera may have more or less keys and more or less icons, than those shown in FIG. 6. Further, the cross key 109b and mode-changing key 109c may lie on the lower side of the panel 110, not on the left side of the panel 110 as shown in FIG. 6.

FIG. 7 is a back view of a digital still camera according to a fifth embodiment of this invention. As FIG. 7 shows, the panel 110 of the camera has one silk-printed part. The silk-printed part lies on the right side of the color LCD 108. It has a display icon 301, a menu icon 302 and a trash icon 303. Note that the display key 109b and mode-changing key 109c are located on the left side of the touch panel 110. The user can operate the camera without concealing the color LCD 108 with the hands, by touching the display icon 301, menu icon 302 or trash icon 303 with the thumb of the right hand and by pushing the cross key 109b or mode-changing key 109c with the thumb of the left hand, for example. The camera may have more or less keys and more or less icons, than those shown in FIG. 7.

FIG. 8 is a back view of a digital still camera according to a sixth embodiment of the invention. As seen from FIG. 8, the panel 110 of the camera has one L-shaped silk-printed part. The silk-printed part lies partly on the left side of the color LCD 108 and partly on the lower side of the color LCD 108. It has a display icon 301 and a menu icon 302 on the vertical part, and a trash icon 303 on the horizontal part. Note that the shutter key 109a, display key 109b and mode-changing key 109c are located on the right side of the touch panel 110. The user can operate the camera without concealing the color LCD 108 with the hands, by touching the trash icon 303, display icon 301 or menu icon with the thumb of the left hand and by pushing the key 109a, key 109b or key 109c with the thumb of the right hand, for example. The camera may have more or less keys and more or less icons, than those shown in FIG. 8. Additionally, the keys may be located on the lower side of the panel 110, not on the right side of the panel 110 as shown in FIG. 8.

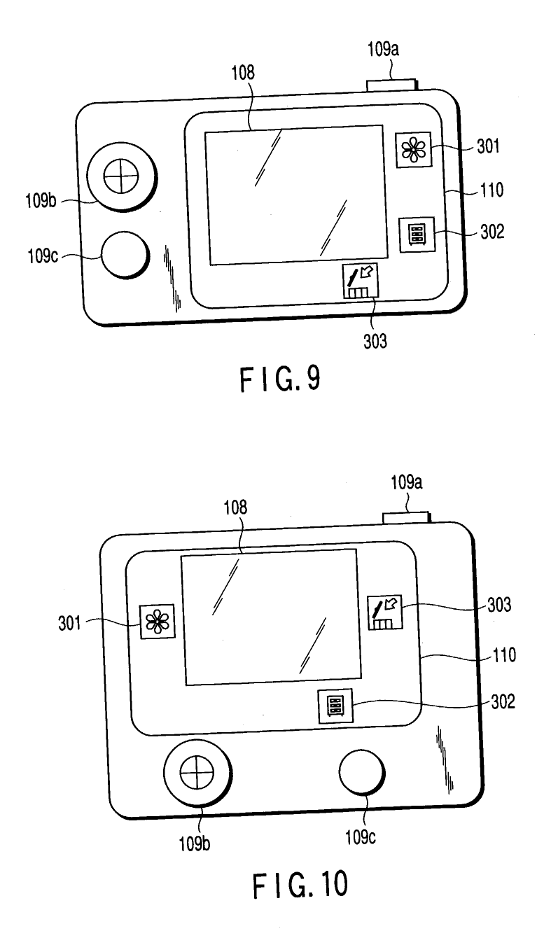

FIG. 9 is a back view of a digital still camera according to a seventh embodiment of the invention. This camera comprises a touch panel 110, a shutter key 109a, a cross key 109b, and a mode-changing key 109c. The touch panel 110 has an L-shaped silk-printed part. The silk-printed part lies partly on the right side of the color LCD 108 and partly on the lower side of the color LCD 108. It has a display icon 301 and a menu icon 302 on the vertical part, and a trash icon 303 on the horizontal part. Note that the shutter key 109a, display key 109b and mode-changing key 109c are located on the left side of the touch panel 110. The user can operate the camera without concealing the color LDC 108 with the hands, by pushing the cross key 109b and mode-changing key 109c with the thumb of the left hand and by touching the display icon 301, menu icon 302 or trash icon 303 with the thumb of the left hand, for example. The camera may have more or less keys and more or less icons, than those shown in FIG. 9. Additionally, the keys 109b and 109c may be located on the lower side of the panel 110, not on the left side of the panel 110 as shown in FIG. 9.

FIG. 10 is a back view of a digital still camera according to an eighth embodiment of the present invention. As FIG. 10 shows, this camera has three silk-printed parts, a shutter key 109a, a cross key 109b, and a mode-changing key 109c. The silk-printed parts are located on the left side of the color LCD 108, on the right and lower sides of the color LCD, respectively. The cross key 109b and mode-changing key 109c are provided on the lower side of the touch panel 110. The user can operate the camera without concealing the color LCD 108 with the hands, by pushing the cross key 109b and display icon 301 with the thumb of the left hand and by pushing the trash icon 303, menu icon 302 and mode-changing key 109c with the thumb of the right hand, for example. The camera may have more or less keys and more or less icons, than those shown in FIG. 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital still camera comprising:
a photographing unit which converts optical image into electric image signal;
a recording unit which records the image signal generated by the photographing unit, on a data-recording medium;
a display unit which has a display screen and which displays an image represented by one of the image signal generated by the photographing unit and the image signal recorded on the data-recording medium;
a touch panel which has a greater area than the screen of the display unit, covers the display screen and is designed to input user instructions; and
a shutter key to set photographing timing,
the shutter key is provided on an upper side of the touch panel, and an operation region to be touched to select a function of the digital still camera is provided on the touch panel, outside the display screen, and on at least one of a left side, right side and lower side of the screen.

2. A digital still camera comprising:
a photographing unit which converts optical images into electric image signal;
a recording unit which records the image signal generated by the photographing unit, on a data-recording medium;
a display unit which has a display screen and which displays an image represented by one of the image signal generated by the photographing unit and the image signal recorded on the data-recording medium;
a key input unit which has a movable mechanical part and which is configured to input user instructions;
a touch panel which has a greater area than the screen of the display unit, covers the display screen and is designed to input user instructions; and
a shutter key to set photographing timing,
the shutter key is at an upper side of the touch panel, and printed pattern to be touched to select function of the digital still camera are provided on the touch panel, outside the screen, and on at least one of a left side, right side and lower side of the screen.

3. A digital still camera according to claim 2, wherein the printed patterns are provided on the left side of the display screen, the key input unit is provided on at least one of the left side and lower side of the display unit.

4. A digital still camera according to claim 2, wherein the printed patterns are provided on the lower side of the display screen, and the key input unit is provided on at least one of the right side and lower side of the display unit.

5. A digital still camera according to claim 2, wherein the printed patterns are provided on the right side of the display screen, and the key input unit is provided on at least one of the left side and lower side of the display unit.

6. A digital still camera according to claim 2, wherein the printed patterns are provided on the left and right sides of the display screen, and the key input unit is provided on the lower side of the display unit.

7. A digital still camera according to claim 2, wherein the printed patterns are provided on the left and lower sides of the display screen, and the key input unit is provided on at least one of the left side and lower side of the display unit.

8. A digital still camera according to claim 2, wherein the printed patterns are provided on the right and lower side of the display screen, and the key input unit is provided on at least one of the left side and lower side of the display unit.

9. A digital still camera according to claim 2, wherein the printed patterns are provided on the left, right and lower sides of the display screen, and the key input unit is provided on the lower side of the display unit.
